(19) United States
(12) Patent Application Publication
(10) Pub. No.: US 2006/0193963 A1
(43) Pub. Date: Aug. 31, 2006

(54) Snack mix of enhanced play value and method of preparation

(76) Inventor: Terry R. Harrington, Albertville, MN (US)

Correspondence Address: GENERAL MILLS, INC., P.O. BOX 1113, MINNEAPOLIS, MN, 55440, US

(21) Appl. No.: 11/316,149

(22) Filed: Dec. 22, 2005

Related U.S. Application Data
(60) Provisional application No. 60/638,901, filed on Dec. 23, 2004.

(51) Int. Cl. A23L 1/164

(52) U.S. Cl. 426/620

(57) ABSTRACT

Snack mixes in the form of loose blends of individual pieces, especially crackers, pretzels, and/or cereal pieces with the pieces including shaped and sized pieces that collectively, can be used to as puzzle member pieces for assembly into a pattern such as form figurines for enhanced play value such as for children. The present methods of preparation involve preparing shaped pieces adapted for assembling into puzzles and blending those shaped pieces to provide loose blends of individual pieces whereby an edible snack blend can be provided having enhanced play value.

This application claims the benefit of priority under 35 U.S.C. §119(e)(1) of a U.S. provisional patent application, Ser. No. 60/638,901, filed Dec. 23, 2004, which is incorporated herein by referenced in its entirety.

### BACKGROUND OF THE INVENTION

The present invention relates to food products and to their methods of preparation. More particularly, the present invention relates to snack mixes in the form of loose blends of individual pieces, especially crackers, pretzels, and/or cereal pieces with the pieces including shaped and sized pieces that collectively, can be used to form figurines for enhanced play value such as for children. The present methods of preparation involve preparing shaped pieces and blending those shaped pieces to provide loose blends of individual pieces whereby an edible snack blend can be provided having enhanced play value.

Snack mixes come in a wide variety of ingredients, flavors, and size and shape of ingredient pieces. For example, a wide variety of granola mixes are well known that comprise cereal ingredients, especially rolled oats sweetened with a binder to form larger pieces. The granola or granola pieces can be admixed with a variety of other ingredients such as dried fruit pieces, for example, raisins or dried apple bits, nuts (such as peanuts or other nut pieces), and candies such as small chocolate pieces.

Also well-known are blends of pretzels, together with other cereal base ingredients such as fried bread slices, crackers and like. Illustrative of those types of a snack mixes are those various blends and flavors available under the Gardetto's™ brand. These snack mixes comprise blends of individual dried pieces of several types of individual taste, size, shape and texture such as small pretzel pieces (such as having chunky exterior salt pieces), fried toast, bagel or bread slices or bread sticks having seasonings (such as garlic or with Italian seasoning), or other cereal based pieces such as biscuits of ready-to-eat cereals. Additionally, the loose blends can the supplied with an additional topical flavor such as a cheese flavor, a Cajun flavor, or savory flavor.

Another well-known snack blend is available under the Chex brand. Such blends include as their principal ingredient, a ready-to-eat cereal piece in the form of a biscuit fabricated from a grid or matrix of cooked cereal dough. In addition to the characterizing biscuit cereal piece, the blend can additionally include such other common cereal pieces such as pretzels or crackers. The individual pretzel pieces have common pretzel shapes such as a simple rod, although more complex pretzel shapes, such as a heart shape, have also been used. Generally however, the pretzel shapes involve a string or strand of pretzel of substantially uniform diameter although the strand itself can be configured into a variety of shapes. The crackers are likewise, usually of simple geometric shapes such as a rod or square flat cracker. Another supplemental shape is a disk shaped piece such as 48 garlic toast slice. In certain television commercials, these simple shapes have been combined in great number to depict various shapes and characters in elaborate displays that often simulate animation.

While such as snack mix blends are popular with adults, these snack mix blends have lesser appeal to children. As is well-known, children, especially younger children, enjoy playing with their food. While playing with children's food is discouraged in some cultures, increasing the play value of foods especially those either specifically targeted two children or stylized as “all-family” (and thus including children) can be an important feature or benefit for such foods.

Accordingly, it is an object of the present invention to provide improved snack mixes of enhanced play value especially for children or as “all-family” snack mix offerings. Surprisingly, such mixes can be provided by including to such conventional mixes quantities of individual pieces that are designed for and can be used to create shapes and figures. The novel shapes that add play value van be creative biscuit and/or pretzels or other shelf stable products fabricated from doughs.

### BRIEF SUMMARY OF THE INVENTION

In its principle product aspect, the present invention provides a snack mix in the form of a loose blend of individual pieces suitable for arranging to form a puzzle. The snack mix includes a quantity of a first dry two dimensional shaped planar piece for forming a puzzle pattern; and,

a quantity a second of dry shaped rod piece for forming a puzzle pattern.

### BRIEF DESCRIPTION OF THE DRAWINGS

FIG. 1A is a plan view of a figurine puzzle assembled from pieces of the snack mix of enhanced play value of the present invention.

FIG. 1B is a plan view of a figurine puzzle assembled from pieces of the snack mix of enhanced play value of the present invention

FIG. 2 is a plan view of a face puzzle assembled from pieces of the snack mix of enhanced play value of the present invention

FIG. 3 is a plan view of a face puzzle assembled from pieces of the snack mix of enhanced play value of the present invention

FIG. 4 is a plan view of a face puzzle assembled from pieces of the snack mix of enhanced play value of the present invention

FIG. 5 is a plan face of a figurine puzzle assembled from pieces of the snack mix of enhanced play value of the present invention

FIG. 6 is a plan view of a face puzzle assembled from pieces of the snack mix of enhanced play value of the present invention

FIG. 7 is a plan view of a face puzzle assembled from pieces of the snack mix of enhanced play value of the present invention

FIG. 8 is a plan view of a clover flower puzzle assembled from pieces of the snack mix of enhanced play value of the present invention

FIG. 9 is a plan view of a shamrock flower puzzle assembled from pieces of the snack mix of enhanced play value of the present invention

FIG. 10 is a plan view of a daisy flower puzzle assembled from pieces of the snack mix of enhanced play value of the present invention

FIG. 11 is a plan view of a face puzzle assembled from pieces of the snack mix of enhanced play value of the present invention

### DETAILED DESCRIPTION OF THE INVENTION

The present invention provides an snack mix food product and methods for their preparation in the form of a loose blend of individual pieces. The present snack mix food product blend includes a quantity of at least one conventional characterizing base type pieces and a quantity of at least two novelty shaped food pieces. The novelty shaped pieces can be a shaped planar piece such as a cracker and a shaped rod piece such as a pretzel. Each of these product components as well as methods for enhancing the play value is described in detail below.

A wide variety of snack mixes are well known. Generally, these snack mixes are in the form of a loose blend of individual dry pieces each weighing about 0.1 to 4 g each. The dry pieces typically have a water activity value to provide extended room temperature shelf stability (when appropriately packaged) generally ranging from about 0.2 to about 0.65. Popular snack mixes are usually identified by at least one well known and characterizing type pieces. For example, the conventional identifiable base piece could be crackers, popped popcorn, peanuts (or other nuts such as almonds or cashews), raisins, pretzels, fried snack products, or ready-to-eat cereal pieces. Well know combinations are can also be used, e.g., caramel coated popped popcorn (sometimes colloquially referred to as “ready-to-eat popcorn”) admixed with peanuts.

Often, the base characterizing type ingredient is a well known and often a branded type piece that can be distinguished by the consumer by well known flavor, shape, type or other product attributes. For example, a wide variety of snack mixes are well known under the ChexMix® brand. Such products include as their characterizing or readily identifiable base type piece the familiar grid pillow ready-to-eat-cereal (“R-T-E”) pieces that is well known and associated with the Chex® brand of R-T-E cereals. While several cereal types are known under this brand such as those prepared from a cooked cereal dough of rice flour, corn flour, wheat flour, each cereal piece regardless of the cereal flour from which fabricated is in the form of the familiar grid pillow piece. In other embodiments, the base characterizing piece can be the familiar “O” shaped R-T-E cereal pieces widely recognized and associated with the Cheerios® brand. In still another embodiment, the characterizing base type pieces can the cornucopia shapes that are sold under the Bugles® mark (see US design 202,609 “Puffed Snack Food Products” issued Oct. 26, 1965 to V. E. Weis). In still other embodiments, the identifying base type ingredient might be corn chips, i.e., a fried snack pieces fabricated from a corn masa dough. Thus, the base characterizing ingredient is most often a cereal base piece such a R-T-E cereal, a cracker, a pretzel, a dried bread piece, a cookie, a fried snack especially fried puffed snacks (e.g., the puffed cornucopia shaped pieces described above) or mixtures thereof. While in the balance of the present description particular attention is made to the grid pillow R-T-E cereal pieces as the base identifying type piece, the skilled artisan will appreciate that the invention is applicable to snack mixes having one or more other base identifying type pieces. The base mix can include variations of the characterizing base ingredient. For example, for Chex™ brand mix product, the mix can include a grid pillow cereal pieces fabricated from a cooked corn based cereal dough as well as similarly shaped biscuit pieces but fabricated from a wheat based cooked cereal dough. In still other variations, the base characterizing type pieces can include candies or confections, nut pieces (e.g., peanuts or chocolate covered peanuts), dried fruit or fruit based pieces (e.g., raisins or chocolate coated raisins), regular pretzels, an the like.

Snack mixes blends typically additionally include at least one and often several other types of pieces admixed or blended with the identifying base types pieces to form a loose blend. Since moisture will migrate within a packaged loose blend, the pieces are selected such as to have the desirable taste, texture and stability features when admixed with dissimilar pieces but of generally equivalent water activity values. For example, the snack mix can include a variety of component to provide a dry blend having a water activity value of 0.40 or less. If the base pieces have a water activity value of 0.3, then good results are obtained when care is exercised to select those ingredients that have a water activity value ranging from about 0.25 to 0.35. Also, the secondary piece types are selected to be relatively robust to resist excessive piece breakage. For this reason, especially frangible pieces such as potato chips or R-T-E cereal flakes, e.g., corn flakes, are generally not employed. Often, the secondary pieces will include a small pretzel piece (i.e., within the above described pieces weight range) generally of simple shapes, e.g., a short rod. Also, the secondary pieces will frequently include a cracker, i.e., a baked planar piece fabricated from a cereal dough. Of course, some mixes will include two or more shapes such as two pretzel shapes or two cracker shapes or include other secondary types of ingredients. However, while the shapes of the secondary pieces can have individual aesthetic appeal, their shapes are not generally related to the shapes of the other ingredients to have play value and especially not to have puzzle type play assembly kit play value. Such planar products will have a length and a width and a thickness. Good results are obtained when the thickness has an aspect ratio to either length or width of 1:5 or less.

The present snack mix blends includes a quantity of at least one such conventional identifying base type pieces. Good results are obtained when the snack mix blends include about 10% to 80%, preferably about 20% to 60% of the identifying type pieces. In the preferred embodiment, at least a portion of the identifying base type ingredient is a R-T-E cereal piece. In a more preferred embodiment, the R-T-E cereal pieces is a grid pillow or biscuit R-T-E cereal piece.

The present snack mix blends include a quantity of at least two novelty shaped pieces at least one of which is a two dimensional or planar piece such as a cracker or cookie and at least on of which is a three dimensional or rod (tube or cylinder) or string type piece such as a pretzel that together with the base characterizing ingredient allow for the user to assemble puzzles from such piece collections. Thus the present snack blends include a quantity of first novelty shaped planar pieces and a quantity of a second rod novelty shaped pieces. Each quantity of shaped first and second novelty shaped pieces can be present in the present snack mix blends ranging from about 10% to 60%, preferably about 10% to 30%.

In additional preferred embodiments, the present snack mixes can additionally comprise at least a third novelty or puzzle shaped piece which can be either a second rod or a planar piece that is different in shape from the first or second or characterizing pieces.. In still other embodiments, the snack mix blends include at least two shaped rod novelty shaped pieces and at least two shaped planar novelty or puzzle pieces or even more differently shaped rod or planar pieces.

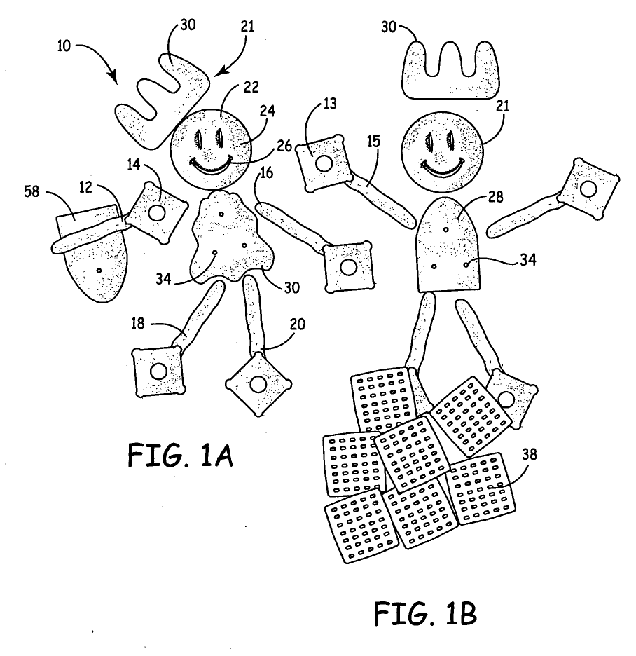

The novelty shaped pieces should relate to each other as individual components of a puzzle, model or kit. To better describe the relationship of the shaped pieces, reference is now first made to FIG. 1A and FIG. 1B. FIG. 1 depicts an arranged assembly of puzzle or model pieces generally designated by reference numeral 10. For convenience of description, such arrangements will be referred to herein as puzzles. In the embodiment of puzzle 10 depicted in FIG. 1A, it can be seen that the snack mix blend includes at least a quantity of a first shaped novelty rod piece such as the limb shaped piece 12. Conveniently, rod piece 12 can be a shaped pretzel. In a preferred embodiment, the limb shaped puzzle piece 12 should be sufficiently reminiscent of a limb to function as limb member puzzle piece of figurine puzzle 21 but also ideally is of a shape sufficiently flexible as to function as limb member in a variety or orientations and capacities. In FIG. 1A, for example, it can be seen that limb rod piece 12 has a shape reminiscent of a traditional Irish cross design including a head portion 13 (comprising a circle with an exterior three cross or cross points) and a depending post or stand portion 15. Piece 12 can function as an arm limb puzzle piece or as a leg member or as a sword. In the particular, Irish cross design piece 12 can have pieces 14 and 16 as arm limbs while like pieces 18 and 20 serve as leg limbs. Also, FIG. 1 shows that piece 12 can be oriented with the head portion 13 extended outward to serve for child play purposes as a foot or hand or with the port portion 15 outwardly extending such that head portion 13 serves as shoulder for play purposes.

FIG. 1 also depicts that the snack mix includes a quantity of at least a second novelty shaped planar piece 22 such as the head or face piece 24 depicted. In particular, face piece 22 is a planar baked shaped cracker having opposed major sides including a first major side having a least three incisions 26 (two eyes and a mouth) thereon to compose a face patterns. Incisions 26 preferably extends through the cracker piece 24 such that the opposed major face (not shown) likewise composes a face pattern. In preferred variations, the snack mix will have a number ratio of eye pieces to mouth pieces of about 2:1.

FIG. 1 also illustrates that the snack mix can include a second shaped rod piece 30 such as the “E” letter shaped depicted. The letter shaped pretzels 30 are preferably selected from the group consisting of letter in the shape wherein the letter shaped piece, whether upper or lower case, is selected from the group consisting of B, C, D, E I, J, M, L, S, O, P, T, V, X, Y, Z and mixtures thereof. Generally, the letter shaped pieces are those most commonly occurring in the language of the target consumer population. For example, for English speaking consumer populations, the mix can then include the consonants “S” and “T” as well as the vowels “E”, “I” and “O”. Such letters are selectively employed since these letters can also function as not only word puzzle pieces but also as puzzle elements. For example, FIG. 1 depicts that pretzel element 30 can also be used as a crown or hat feature for the figurine puzzle 21. While Latin alphabet letters are preferred herein, the skilled artisan will appreciate that letters from other common language groups can also be used including letters from Greek (especially the letters Γ, Θ, Ψ, Π, Σ, Λ, T, X), Cyrillic (especially the letters [symbol] , Γ, [symbol] , [symbol] , M, O, Π, P, C, T, [symbol] , III, Φ,), Hebrew, and/or Arabic and mixtures thereof. The specific letter from the Greek and Cyrillic alphabets are likewise selected for their dual functionality. Also, both upper and lower case letters are contemplated. Preferred herein are block (especially sans serif versions) letters rather than script letters.

In still other embodiments, the snack mix blends can additionally include additional shaped puzzle type pieces. For example, FIG. 1B depicts that a shield shaped cracker piece 28 an be used as a body member or as a figurine accoutrement as in FIG. 1A. Other variations include the particular shield shaped piece 30 having a scalloped free edge or border or other peripheral outline design. The same design can be imaginatively used as face cracker. Conveniently, the cracker pieces can each include one or more docking holes 34 or other cracker surface feature that if desired can be sized and positioned and shaped to provide an ornamental feature or arrangement (as more fully described below).

FIG. 1 also illustrate that the identifying pieces such as the grid pillow R-T-E cereal piece 38 can now be more playfully employed by virtue of the inclusion of the novelty pieces described above. For example, in FIG. 1B, the figurine 21 is seen standing on a small hill assembled from pieces 38.

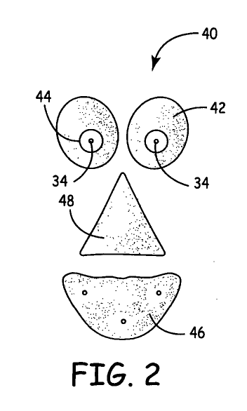

Referring now briefly to FIG. 2, it can be seen that in another embodiment, the snack mix can include shaped novelty or puzzle pieces for assembling a face type puzzle 40 rather than a figurine. In this embodiment, a shaped cracker 42 in the form of an oval is used as an eye puzzle piece. Cracker 42 includes a docking hole 34 that is positioned to provide a eye pupil feature whose suggestiveness is enhanced by including a surrounding surface ridge feature 44 to cracker 42. FIG. 2 also depicts that the snack mix for a face puzzle in addition to eye puzzle pieces 42 should include a shaped novelty piece 46 for a mouth feature such as the hemi-oval shape of piece 46. FIG. 2 likewise illustrate that mixes comprising simple geometric shapes such as piece 48 having a triangle shape can now be more playfully employed by virtue of the inclusion of the novelty pieces described above such as to be used a nose member of face puzzle 40.

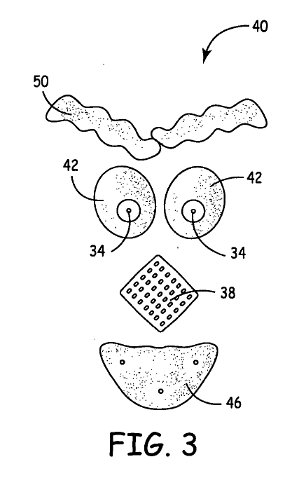

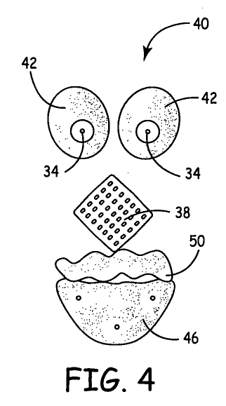

Referring now to FIG. 3, it can be seen that the snack mix identifying piece such as R-T-E cereal piece 38 can now be playfully employed as a puzzle piece member. Snack mix blend's pretzel member can be seen in FIG. 3 to be provided by the scalloped rod pretzel piece 50. In FIG. 3, two pretzel shaped pieces 50 serve as eyebrow members for face puzzle 40. Referring now briefly to FIG. 4, it can be seen that a single shaped pretzel piece 50 can serve as a mustache member for face puzzle 40.

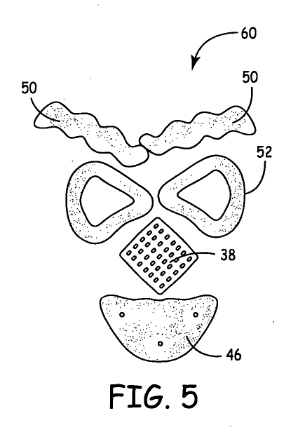

Reference is now made to FIG. 5 which depicts a face puzzle 60. FIG. 5 depicts that in another variation, the snack mix blend can include the identifying shaped piece such as grid biscuit piece 38. The face puzzle and snack mix containing the puzzle's members can include a shaped cracker puzzle piece members such as mouth or hemi-oval shaped cracker 46. The snack mix also includes the first shaped pretzel member 50. In this variation, the snack mix blend can include a quantity of a second shaped pretzel type such as the petal shaped pretzel 52 depicted. Pretzel pieces 52 can be arranged and oriented to serve as eye members in face puzzle 60.

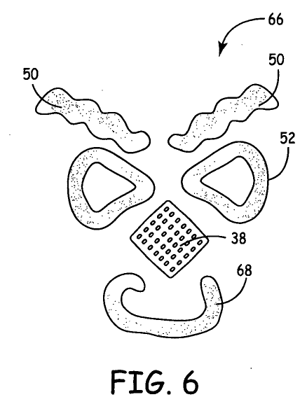

Referring now to FIG. 6, there is shown a face puzzle 66. Face puzzle 66 is assembled using shaped pretzel type 50 as eyebrow members or pieces, with petal shaped pretzel pieces 50 serving a eye puzzle member pieces, with grid shaped identifying piece 38 serving a nose face puzzle member and additionally comprising a letter shaped pretzel such as the “C” shaped pretzel member 68 serving as a mouth puzzle member. In this variation, the snack mix can include three types of shaped pretzel novelty or puzzle member pieces in addition to the identifying shaped type piece.

Reference now is made briefly to FIG. 7 that depicts a face puzzle 70 that is similar to face puzzle 66 except substituting common geometric shape such a triangle shaped cracker piece 48 as nose puzzle member. Also, face puzzle 70 adds an extra scalloped pretzel rod piece 72 to add a whimsical cigar feature.

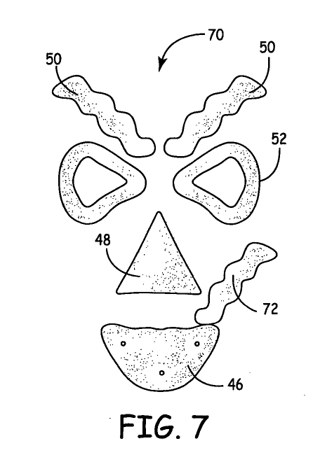

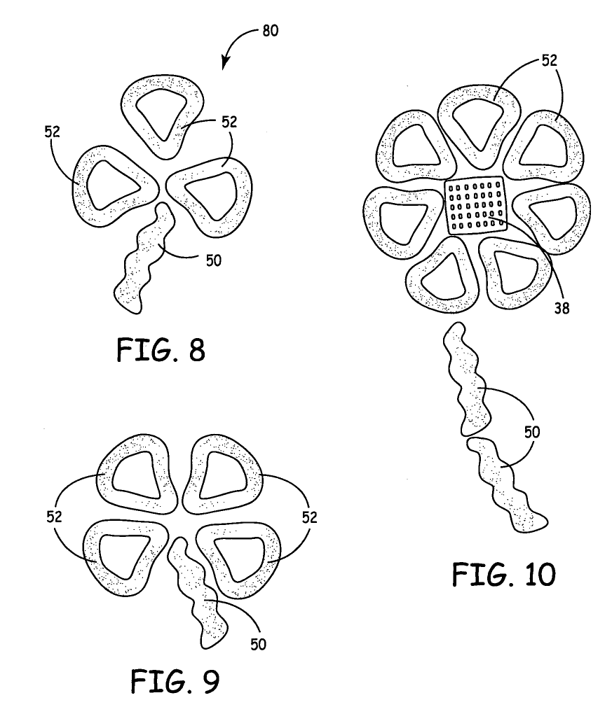

Reference is now made to FIG. 8-10. FIG. 8 illustrates a flower puzzle 80 such as the specific clover food puzzle 82. The flower puzzle 80 can be assembled from and can include three shaped pretzel pieces 52 having a peddle shape together with one or more scalloped rod pretzel shaped pieces 50. FIG. 8 illustrate that a sub-set of shapes can be used to assemble more than a single shape. FIG. 9 illustrates that with a slight variation using an additional piece of shape 52, a flower puzzle of the beloved shamrock can be constructed. This use feature is also illustrated in FIG. 10 that depicts a more complex flower puzzle that utilizes the pretzel pieces 50 and 52 s well as identifying shaped piece 38

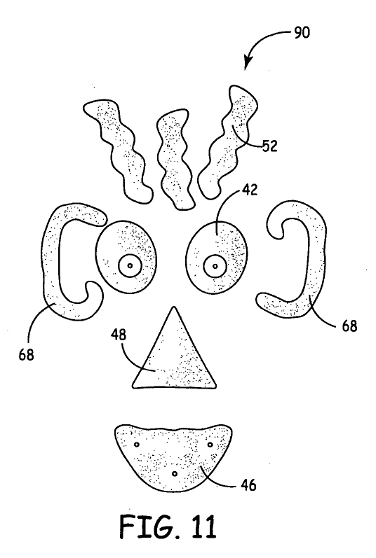

Finally, reference is made to FIG. 11 which shows a puzzle face

All manner of puzzles can be devised to practice within the scope of the present invention. For example, a wide variety of face puzzle for all manner of creatures. Also, various figurine puzzles whether for animals, vehicles plants, or monuments using a simple set of shaped pretzel and or planar members especially crackers. Of course, other shaped planar, or two dimensional, dry food pieces especially cookies can be used. For example, the planar or rod shaped pieces can be candies, licorice, dried marshmallow or other dried aerated confections, jelled candies or gelled fruit juice pieces, puffed shaped fried snack pieces, fruit pieces fabricated from dried fruit purees, formed dried meat snacks, and mixtures thereof. Also, other shaped rod or tubular, or three dimensional products, can be used in substitution for the pretzel, e.g., bread sticks or puffed fried shaped rod or tubular snack pieces such as fried corn puffs. It will be appreciated that such pieces are shelf stable (generally having a water activity value of 0.45 or less, e.g., about 0.1-0.45 to allow for extended shelf stability when packed in a moisture barrier food packaging. Depending upon the particular type of piece, the pieces can be flexible or stiff, deformable, frangible, chewy or crunchy. While particular attention is made for mixes that are suitable for consumption as a snack mix, in other variations, blends can be marketed for consumption as cold or ready-to-eat breakfast cereals.

The present snack mix blends can additionally comprise a seasoning flavoring to all or a portion of the pieces. For example, a dried cheese flavoring (0.5% to 4% of the snack mix) can be topically applied to a quantity of the identifying shaped piece such as the grid pillow piece 38. Thereafter, these seasoned pieces can be admixed with quantities of the other shaped pieces to form the present snack mix blend of enhanced play value. Other seasoning flavors, e.g., barbeque, Cajun, Italian, jerk or Caribbean, Mexican, pizza, salsa, savory, and/or soy can be applied. In other variations, a sweetener especially a high potency sweetener (e.g., aspartame, sucralose, acetylsulfame, e.g., ace-K, and mixtures thereof) can be included such as by topical application. If desired all or a portion of the pieces can additionally include a sugar coating especially of low calorie coating such as provided by tagatose). In still other variations, the novel shaped pieces can be flavored or seasoned, e.g., with topically applied salt or fabricated from a flavored cereal composition.

In other variations, the snack mix can additionally comprise one or more additional or supplemental shelf stable (especially having a water activity value of less than 0.44 preferably less than 0.4) adjuvant pieces such as dried marshmallow bits or marbits, dried confections especially dried aerated confections, raisins or other dried fruit pieces, dried meats, nuts and nut pieces, dried bread (e.g., garlic bread slices), popped popcorn (especially sugar coated or caramel popcorn) and mixtures thereof. If present such adjuvant pieces can comprise about 1% to 30% of the present snack mix blends. It will be appreciated that certain of these adjuvant added components can be compositionally similar to those novel shaped pieces described above but lacking the specific puzzle shape.

The present snack mixes can be conveniently packaged in familiar food packaging especially bas or pouches fabricated from sealed moisture loss resistant flexible packaging film. A quantity e.g., 30 g to 3 kg, can be disposed within a suitable container or bag for either retail sale or for food service sales (e.g., kindergarten cafeterias). In less preferred embodiments, the food packaging can be a tin or a can. While such stronger containers can provides more robust storage protection, the containers can be expensive.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

1. A snack mix in the form of a loose blend of individual pieces suitable for arranging to form a puzzle, comprising
a quantity of a dried characterizing base snack mix pieces;
a quantity of a first dry two dimensional shaped planar piece for forming a puzzle pattern; and,
a quantity a second of dry shaped grain based rod piece for forming a puzzle pattern.

2. The dry mix of claim 1, additionally comprising: a quantity of a third dry identifying piece selected from the group consisting of crackers, ready-to-eat cereals, popped popcorn, cookies, crackers, fried grain snack.

3. The dry mix of claim 2 additionally comprising a quantity of a particulate ingredient selected from the group consisting of dried marshmallows, nuts, dried fruits, candies, chocolate, and mixtures thereof.

4. The dry mix of claim 1 wherein the first dry shaped planar piece is an eye piece and wherein the second dry shaped planar piece is a mouth piece.

5. The dry mix of claim 2 wherein the identifying piece is a ready-to-eat cereal.

6. The dry mix of claim 5 wherein the ready-to-eat cereal comprises a grid puffed pillow.

7. The dry mix of claim 1 wherein the pieces have a size count ranging from about 1 to 20/g.

8. The dry mix of claim 1 wherein the dry shaped planar piece is a cracker.

9. The dry mix of claim 8 wherein the dry shaped rod piece is a pretzel.

10. The dry mix of claim 8 including at least two types of shaped baked crackers.

11. The dry mix of claim 8 including at least two types of shaped pretzels.

12. The dry mix of claim 2 wherein the identifying type piece is a fried grain snack selected from the group consisting of corn chips and puffed grain snacks.

13. The dry mix of claim 12 wherein the identifying type piece is a puffed grain snack in the form of a cornucopia.

14. The dry mix of claim 8 wherein the crack has at least three incisions forming a face pattern.

15. The dry mix of claim 9 wherein the pretzel piece in the form of a letter.

16. The dry mix of claim 15 wherein the letter shaped piece is selected from the group consisting of C, I, L, S, O, P, X, E, J, M, T, V, and mixtures thereof.

17. The dry mix of 1 disposed within a package fabricated at least in part of a flexible packaging film.

18. The dry mix of claim 1 wherein at least on shape is a cracker and at least one shape is a pretzel

19. The snack mix of claim wherein at least one quantity of pieces includes a dry topical flavor powder.

20. A method of enhancing the play value of a snack mix for assembling a puzzle, comprising the steps of:
providing a snack mix in the form of a loose blend of a quantity of a first dry identifying shaped piece;
admixing a first quantity of a first puzzle member shaped piece fabricated from a dry food composition; and,
admixing a second quantity of a second puzzle member shaped piece fabricated from a dry food composition to form a puzzle snack mix.

21. A snack mix in the form of a loose blend of individual pieces suitable for arranging to form a play figurine pattern, comprising:
a quantity of a first dry shaped cereal based planar pieces selected from the group consisting of:
eye shaped planar baked cracker pieces,
teardrop shaped baked cracker pieces,
shield shaped baked cracker pieces,
planar baked hemi-ovoid pieces,
planar baked crackers having opposed major faces at one major face having at least three incisions thereon forming a face pattern; and mixtures thereof;
a quantity a second of dry pretzel base pieces selected from the group consisting of:
scalloped baked pretzel rods,
teardrop shaped pretzel pieces,
letter shaped baked pretzel pieces,
limb suggestive shaped baked pretzel pieces,
and mixtures thereof; and,
a quantity of a third dry shaped cereal based planar pieces wherein the shapes are planar baked geometric shapes selected from the group consisting of ovals, rings, circles, triangles, squares, rectangles, parallelograms, pentagons, hexagons, octagons, saddles, and mixtures thereof.
